(19) United States
(12) Patent Application Publication
(10) Pub. No.: US 2012/0262810 A1
(43) Pub. Date: Oct. 18, 2012

(54) FLEXIBLE COLOR FILTER AND METHOD FOR MANUFACTURING THE SAME

(75) Inventors: CHUNG-WEI WANG, Tu-Cheng (TW); CHIU-HSIUNG LIN, Tu-Cheng (TW)

(73) Assignee: HON HAI PRECISION INDUSTRY CO., LTD., Tu-Cheng (TW)

(21) Appl. No.: 13/191,465

(22) Filed: Jul. 27, 2011

(30) Foreign Application Priority Data
Apr. 12, 2011 (TW) 100112527

(51) Int. Cl. G02B 5/22; B05D 3/06

(52) U.S. Cl. 359/891; 427/558

(57) ABSTRACT

A method of manufacturing a color filter includes steps of applying transparent photosensitive material on a transparent flexible substrate, having a plurality of recesses on the photosensitive material to form the photosensitive material into a plurality of banks on the transparent flexible substrate, the banks cooperatively defining a plurality of pixel accommodation rooms. Curing the banks and disposing color ink into the pixel accommodation rooms, at last curing the color ink. The light transmittance ability of the color filter can be effectively improved by forming transparent banks instead of a black-matrix on the substrate. A related display is also provided.

### BACKGROUND

1. Technical Field

The present disclosure relates to color filters and methods of manufacturing a color filter, especially to a method of manufacturing a flexible color filter.

2. Description of Related Art

For displaying colorful images, a color filter matrix is overlaid on a flat display panel, such as a liquid crystal display (LCD), or electrophoretic display. The color filter involves a black matrix pattern and three primary color cell patterns (typically red, blue and green) within the spaces outlined by the black matrix.

A fabrication method for forming a color filter layer by inkjet printing has been developed recently. With this conventional fabrication method, first, a black matrix layer and a first light shielding are disposed on a substrate, then a black matrix is formed by patterning the first light shielding layer. Second, a second light shielding layer is disposed on the black matrix, then a number of walls are formed on the black matrix by patterning the second light shielding layer. An inkjet printing process is then performed to inject a color ink (red, green, or blue) to fill the spaces between the walls. Next, a thermal baking process may be performed to solidify the color ink. In the above conventional fabrication method, the substrate needs to be exposed and developed twice, this kind of fabrication method is complicated and leads to reduction in the accuracy of the black matrix.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a flowchart of a process of manufacturing a color filter in accordance with a first embodiment.

FIGS. 2A-2E are schematic cross-sectional views illustrating a process of manufacturing a color filter according to the first embodiment of FIG. 1.

FIG. 3 is a schematic view of a mold according to the first embodiment of FIG. 2.

FIG. 4 is a schematic view of a mold according to another embodiment of FIG. 2.

FIG. 5 is a flowchart of a process of manufacturing a color filter in accordance with a second embodiment.

FIGS. 6A-6E are schematic cross-sectional views illustrating a process of manufacturing a color filter according to the second embodiment of FIG. 4.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

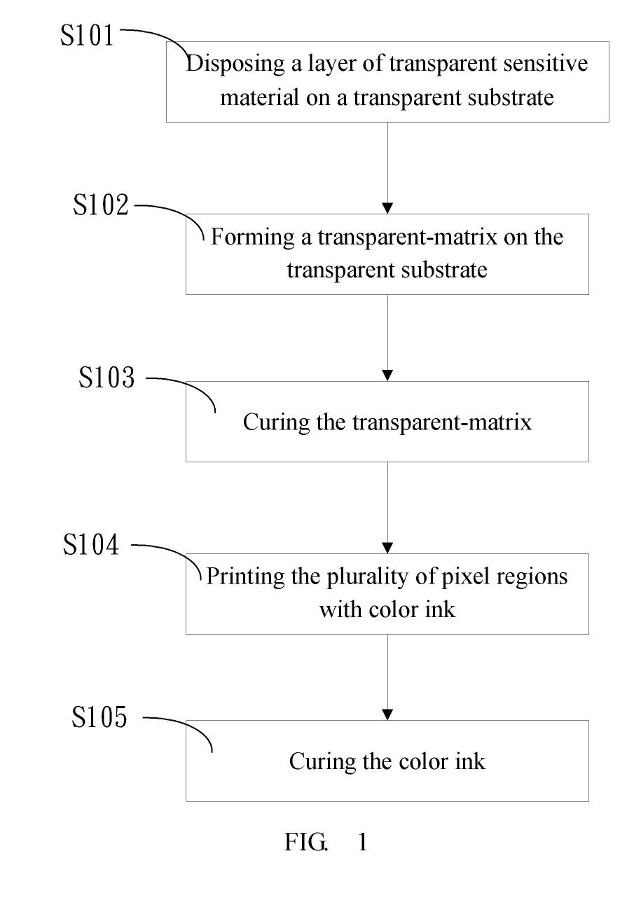

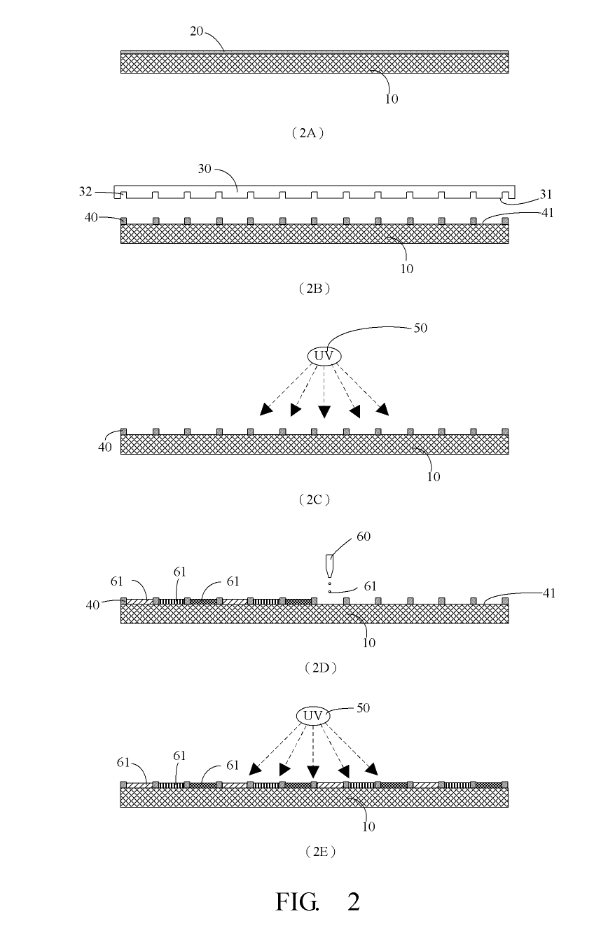

Referring to FIGS. 1, and 2A-2E, a process of manufacturing a color filter is illustrated according to a first embodiment.

In step S101, applying transparent photosensitive material on a transparent substrate. Referring to FIG. 2A, a transparent photosensitive layer 20 is printed on the surface of a transparent substrate 10. The substrate 10 can be made of flexible plastic with high transmissivity, such as polyimide (PI), polycarbonate (PC), or polyethylene terephthalate (PET) or polymethylmethacrylate (PMMA). In the first embodiment, the substrate 10 is made of PET. The substrate 10 also can be made of glass or other rigid material with high transmissivity. The transparent photosensitive layer 20 can be made of photosensitive resin material. In this embodiment, the transparent photosensitive layer 20 is made of ultraviolet-curing (UV-curing) photosensitive resin.

In step S102, pressing a mold having a number of recesses on the layer of transparent photosensitive material to form the photosensitive material into a plurality of banks on the transparent substrate, the banks cooperatively defining a plurality of pixel accommodation rooms.

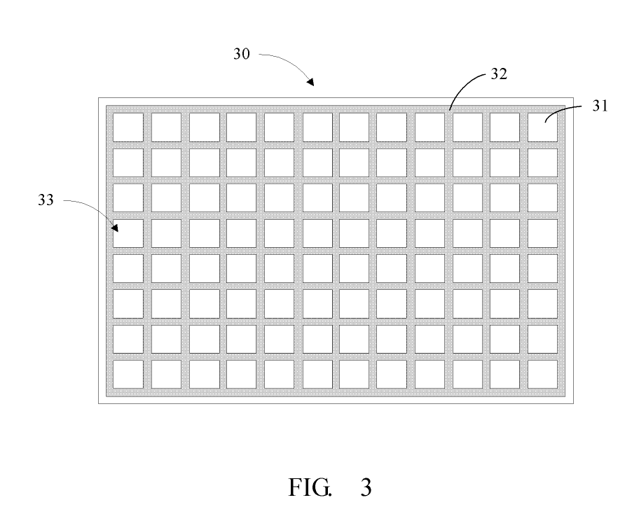

Referring to FIG. 3, a mold 30 is shaped like a rectangular plate. The mold 30 includes a flat pressing surface 33 and a protuberance matrix 31. The protuberance matrix 31 defines a number of recessed patterns 32 on the flat pressing surface of the mold 30. Referring to FIG. 2B, the mold 30 is pressed on the transparent photosensitive layer 20, forcing the transparent photosensitive material into the recessed patterns 32. After removing the mold 30, the transparent photosensitive material filling in the recessed patterns 32 forms a plurality of banks 40 protruding on the surface of the substrate 10. The banks 40 cooperatively define the substrate 10 to a plurality of pixel accommodation rooms 41. The thickness of the transparent photosensitive layer 20 is about 3-10 microns, and the depth of the recessed patterns 32 is lesser than the thickness of the transparent photosensitive layer 20.

In this embodiment, the mold 30 is made of metal, and the recessed patterns 32 can be formed via etching, laser engraving or mechanical treatment et al. The transparent photosensitive layer 20 is made of photosensitive resin material with low fluidity and high viscosity, so the banks 40 can keep its shape after removing the mold 30.

In step S103, curing the banks. Referring to FIG. 2C, the substrate 10 is exposed under ultraviolet radiation (UV) rays source 51, the banks 40 is cured by UV rays.

In step S104, disposing color ink into the pixel accommodation rooms. Referring to FIG. 2D, an inkjet printing process is performed to inject color ink 61 including red ink, green ink and blue ink to the pixel accommodation rooms 41 defined by the banks 40, a nozzle 60 is employed to inject the color ink 61. The banks 40 works as a wall to mainly separate different colors of the ink, for banks 40, the color inks 61 in each of the pixel accommodation rooms 41 cannot overflow to the adjacent pixel accommodation room.

In the first embodiment, the color ink 61 can be a UV-curing ink containing a pigment providing the color, resin adhesive, photopolymerization initiation, dispersing agent and other additives. The pigment in red ink can be naphthol red pigment or azo condensation pigment, the pigment in green ink can be phthalocyanine pigment, and the pigment in blue ink can be metal phthalocyanine.

In step S105, curing the color ink. Referring to FIG. 2E, the substrate 10 is exposed in the ultraviolet radiation (UV) source 51, the color ink 61 is cured by the UV rays and forms a color filter stacked on the surface of the substrate 10. The thickness of the color filter can be controlled to 0.1˜10 microns by controlling the amount of the color ink 61 injected by the nozzle 60.

In another embodiment, the color ink 61 also can be a thermo-curing ink containing pigment providing the color, resin glue, thermal polymerization initiation, dispersing agent and other additives. While the color ink 61 is thermo-curing ink, in the step S105, a thermal baking process is performed to cure the color ink 61.

In another embodiment, the transparent photosensitive layer 20 is made of photosensitive resin material with low viscosity. The photosensitive resin material filling in the recessed patterns 32 forms banks 40 protruding on the surface of the substrate 10, but the banks 40 cannot keep its shape after removing the mold 30. In this case, in steps S102 and S103, after pressing the mold 30 on the transparent photosensitive layer 20, the substrate 10 is exposed under the UV ray source 51 directly without removing the mold 30. In step S103, the UV ray source 51 is arranged on the side of the substrate 10, and the UV pass through the substrate 10 to cure the photosensitive resin material filling in the recessed patterns 32, to form the banks 40. In other embodiments, the UV source 51 also can be arranged on the side of the mold 30, in this manner, the mold 30 is made of transparent plastic material or glass, and the UV passes through the mold 30 to cure the photosensitive resin material filling in the recessed patterns 32. After curing the banks 40, the mold 30 is removed.

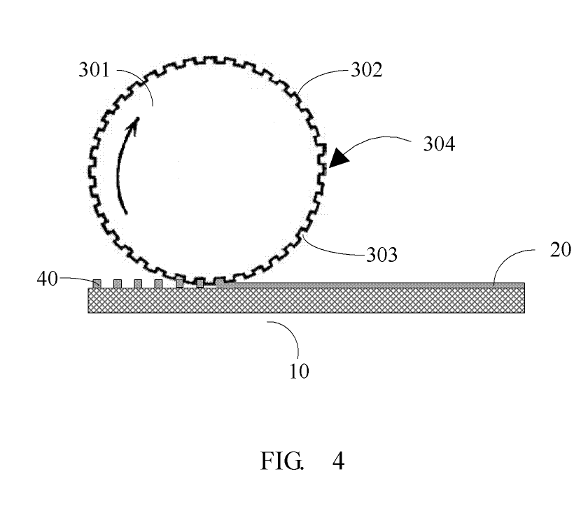

In another embodiment, referring to FIG. 4, the mold 30 is shaped like a roller 301 including a cylindrical pressing surface 304, a protuberance matrix 302 and a number of recessed patterns 303 defined by the protuberance matrix 302. The roller 301 rolls and contacts the transparent photosensitive layer 20, the transparent photosensitive material fills into the recessed patterns 303 to form the banks 40 protruding on the surface of the substrate 10.

The color filter according to the first embodiment, can be formed on the flexible substrate, thus the color filter can be stacked on an black-white electrophoretic display without generating inner gas-holes.

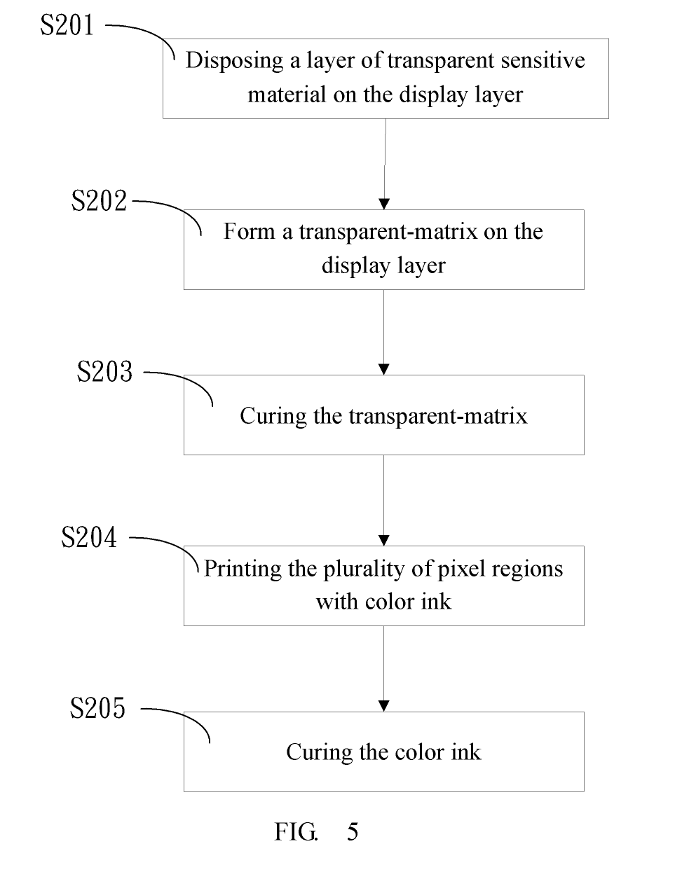

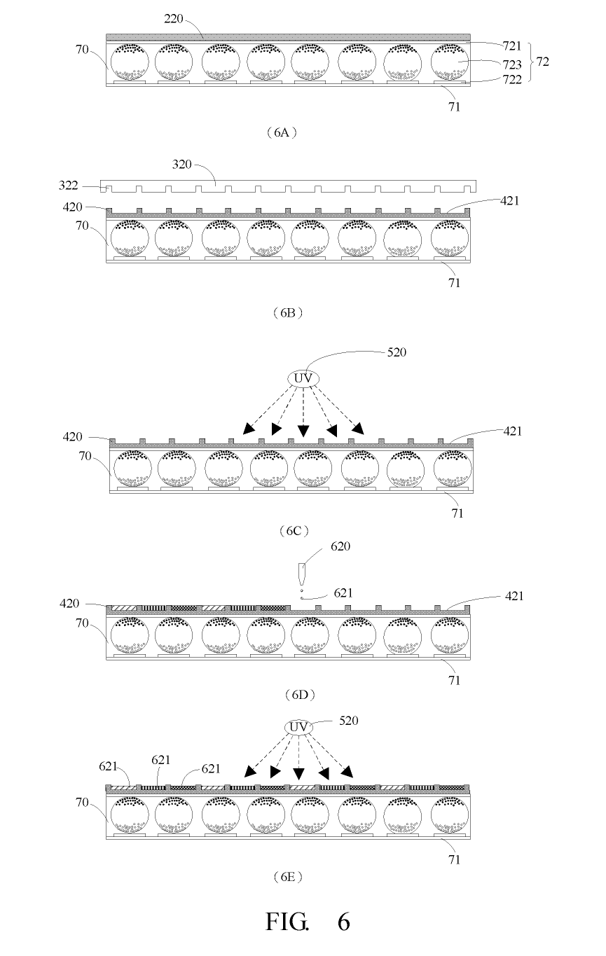

Referring to FIGS. 5 and 6A-6E, a process of manufacturing a color filter 73 on a reflective display 70 is illustrated according to a second embodiment.

In the second embodiment, the reflective display 70 is a black-white electronic paper (E-paper) includes a substrate 71, a display layer 72. The display layer 72 includes a first electrode 721, an electrophoretic ink layer 723, and a second electrode 722, voltage applied to the first electrode 721 and the second electrode 722 causes the electrophoretic ink layer 723 to change the optical state, to display the content on the E-paper. In other embodiment, the reflective display 70 can be an electrowetting display, a microcapsule E-paper display, a micro-cup E-paper display or an interferometric display et al.

In step S201, applying transparent photosensitive material on the display layer.

Referring to FIG. 6A, a transparent photosensitive layer 220 is printed on the surface of the display layer 72.

In step S202, pressing a mold having a number of recesses on the layer of transparent photosensitive material to form the photosensitive material into a plurality of banks on the display layer. Referring to FIG. 6B, in this embodiment, step S202 is similar to step S102 described above, a mold 320 with a number of recessed patterns 322 is pressed on the transparent photosensitive layer 20 to form banks 420. In the second embodiment, the thickness of the transparent photosensitive layer 20 is about 5 microns, and the depth of the recessed patterns 322 is about 3 microns.

In step S203, curing the banks. Referring to FIG. 6C, the reflective display 70 is exposed under an ultraviolet radiation (UV) ray source 520, the banks 420 is cured by UV rays. The banks 420 divides the display layer 72 to a plurality of pixel accommodation rooms 421.

In step S204, disposing color ink into the pixel accommodation rooms. Referring to FIG. 6D, an inkjet printing process is performed to inject color ink 621 to the pixel accommodation rooms 421 defined by the banks 420, a nozzle 620 is employed to inject the color ink 621.

In step S205, curing the color ink. Referring to FIG. 6E, the reflective display 70 is exposed in the ultraviolet radiation (UV) ray source 520, the color ink 621 is cured by the UV and forms a color filter stacked on the surface of the display layer 72. The light transmittance ability of the color filter can be effectively improved by forming a banks instead of a black-matrix on the substrate.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A method of manufacturing a flexible color filter, comprising:
applying transparent photosensitive material on a transparent substrate;
pressing a mold having a plurality of recesses on the photosensitive material to form the photosensitive material into a plurality of banks on the transparent substrate, the banks cooperatively defining a plurality of pixel accommodation rooms;
curing the banks using UV light;
disposing color ink into the pixel accommodation rooms; and
curing the color ink.

2. The method according to claim 1, wherein the mold is a rectangular plate having a flat pressing surface and the plurality of recesses defined in the pressing surface.

3. The method according to claim 1, wherein the mold is a roller having a cylindrical pressing surface and the plurality of recesses defined in the pressing surface.

4. The method according to claim 1, wherein the transparent flexible substrate is made of a material selected from the group consisting of polyimide, polycarbonate, polymethylmethacrylate, and polyethylene terephthalate.

5. The method according to claim 1, wherein the color ink is a UV-curable ink.

6. The method according to claim 5, wherein the color ink is cured using a UV-curing process.

7. The method according to claim 1, wherein the color ink is a low temperature curing ink.

8. The method according to claim 7, wherein the color ink is cured using a thermal baking process.

9. A method of manufacturing a reflective display device, comprising:
providing a reflective display comprising a display layer;
applying transparent photosensitive material on a transparent flexible substrate;
pressing a mold having a plurality of recesses on the photosensitive material to form the photosensitive material into a plurality of banks on the transparent flexible substrate, the banks cooperatively defining a plurality of pixel accommodation rooms;
curing the banks using UV light;
disposing color ink into the pixel accommodation rooms; and
curing the color ink.

10. The method according to claim 9, wherein the reflective display is selected from the group consisting of an electrowetting display, a microcapsule E-paper display, a micro-cup E-paper display and an interferometric display.

11. The method according to claim 9, wherein the mold is a rectangular plate having a flat pressing surface and the plurality of recesses defined in the pressing surface.

12. The method according to claim 9, wherein the transparent photosensitive material is made of photosensitive resin.

13. A flexible color filter, comprising:
a transparent flexible substrate;
a plurality of banks formed on the transparent flexible substrate, the banks cooperatively defining a plurality of accommodation rooms, wherein the banks are formed by pressing a mold having a plurality of recesses on a transparent UV curable material layer disposed on the transparent flexible substrate; and
solidified color ink formed in the accommodation rooms.

14. A reflective display comprising:
a deformable reflective display comprising a bendable display layer;
a color filter formed on the display layer, the color filter comprising
a transparent flexible substrate;
a plurality of banks formed on the transparent flexible substrate, the banks cooperatively defining a plurality of accommodation rooms, wherein the banks are formed by pressing a mold having a plurality of recesses on a transparent UV curable material layer disposed on the transparent flexible substrate; and
solidified color ink formed in the accommodation rooms.
